(19) United States
(12) Patent Application Publication
(10) Pub. No.: US 2003/0094817 A1
(43) Pub. Date: May 22, 2003

(54) Mini-storage door latch

(75) Inventor: M. David Boothe, Baytown, TX (US)

Correspondence Address: GARY L. BUSH, ANDREWS & KURTH, MAYOR, DAY, CALDWELL & KEETON L.L.P., 700 LOUISIAN, SUITE 1900, HOUSTON, TX, 77002, US

(73) Assignee: LANDMARK INTEREST CORPORATION

(21) Appl. No.: 09/989,555

(22) Filed: Nov. 20, 2001

(51) Int. Cl. E05C 1/06

(52) U.S. Cl. 292/38

(57) ABSTRACT

The present invention is directed to an improved latching mechanism for use on doors and in particular, mini storage doors. The improved latching mechanism includes a latch and latch plate which permits the latch to have an open position and a closed position. Attached to the latch is at least one loop, whereby a person can insert a finger or prosthesis into the loop to facilitate moving the improved latch from its closed position to its open position and vice versa.

### BACKGROUND OF THE INVENTION

1. Field of the Invention

The invention is directed to an improved door latch for assisting physically impaired individuals having prosthetics arms, or who are otherwise incapable of gripping objects such as door knobs, to move the door latch from its open position to its closed position, and vice versa, and in particular, to an improved sliding door latch for a roll-up door such as those found on a mine-storage unit.

2. Description of the Prior Art

It is generally recognized that handicapped people face a variety of problems in dealing with the normal situations of everyday living that non-handicapped people never encounter. Additionally, certain types of handicapped individuals are impaired or impeded by their disability from performing some of the most rudimentary tasks of daily life. The extent to which a handicapped person is prevented from performing a particular task may depend largely on the type of handicap involved, since each handicap of a person presents unique problems and challenges which the handicapped person must overcome as best he can. In this regard, the present invention is primarily directed toward addressing a particular problem faced by handicapped persons have prosthetic arms or are unable to grip objects due to arthritis, but do have the ability to insert an arm or finger into a loop.

Various prior door latches designed to assist physically impaired people open and close doors are known in the art. For example, U.S. Pat. No. 5,540,468 issued to Fassman, discloses a door opening and closing device for a handicapped person. The device includes a reel rotatably mounted within a housing around which is a flexible member. One end of the flexible member is secured within the housing and the second end of the flexible member includes a grasping member that is placed around the doorknob so that the person can open the door, pass through the door, and close the door. In doing so, the grasping member is secured to the doorknob. As the person passes through the door, the flexible member is extended sufficiently to permit the person to clear the doorway. Thereafter, the person can pull on the flexible member and thus, the door, to close the door behind him.

Additional door latches are also known in the art. For example, U.S. Pat. No. 1,603,722 issued to Stanley and U.S. Pat. No. 2,741,504 issued to Dale disclose a plate and lever respectively that, when depressed, result in the doorknob being turned and the door being permitted to be opened. Likewise, U.S. Pat. No. 1,264,244 issued to Woiwod discloses a lever that, when depressed, results in the latch being released from its closed position and permitting a swinger gate to be opened.

### SUMMARY OF THE INVENTION

The objects identified along with other features and advantages are an improved latching mechanism, which includes a latch having a loop, wherein the loop is arranged and designed so that a prosthetic arm, hand, or finger, or other object can be put through the loop and pull latch from an open position to a closed position and vice versa.

### BRIEF DESCRIPTION OF TIE DRAWINGS

The objects, advantages and features of the invention will become more apparent by reference to the drawings which are appended hereto and wherein like numerals indicate like parts and wherein an illustrative embodiment of the invention is shown, of which:

FIG. 1 is an embodiment of the invention showing a front view of the latching mechanism on a door;

FIG. 2 shows a detailed view of the latching mechanism in the “closed” position; and

FIG.3 shows a detailed view of the latching mechanism in the “open” position.

While the invention will be described in connection with the preferred embodiment, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF THE INVENTION

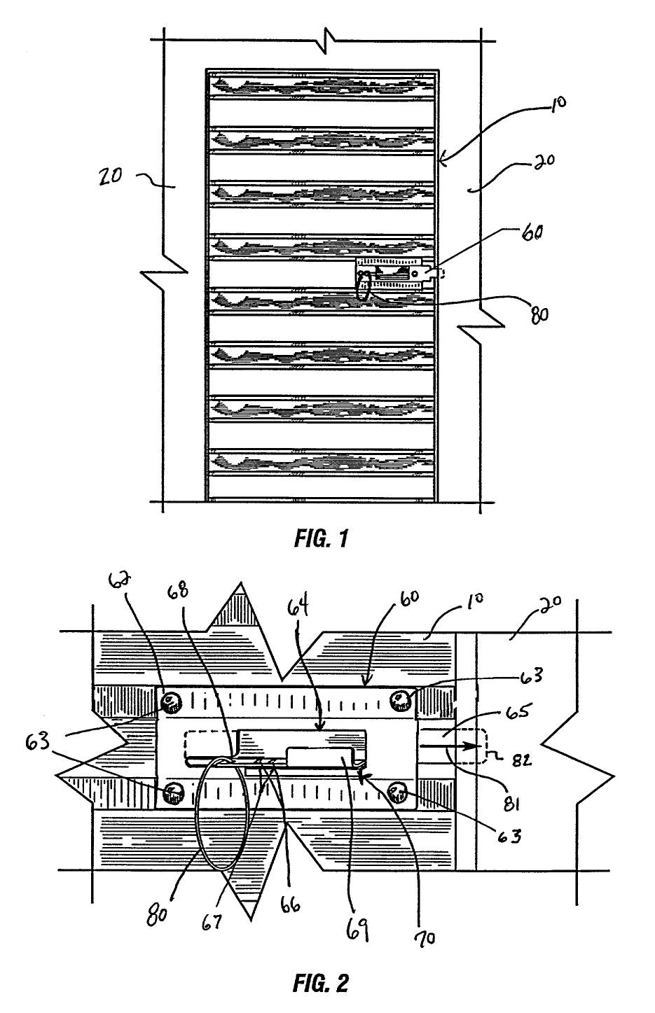

FIG. 1 shows a front view of one embodiment of the invention. Door 10 is surrounded on all sides by wall 20. Latching mechanism 60 is connected to door 10. Loop 80 is connected to latching mechanism 60. The dotted lines at latch locking piece 65 indicate that latch locking piece 65 extends into wall 20 when the latching mechanism 60 is in the “closed” position.

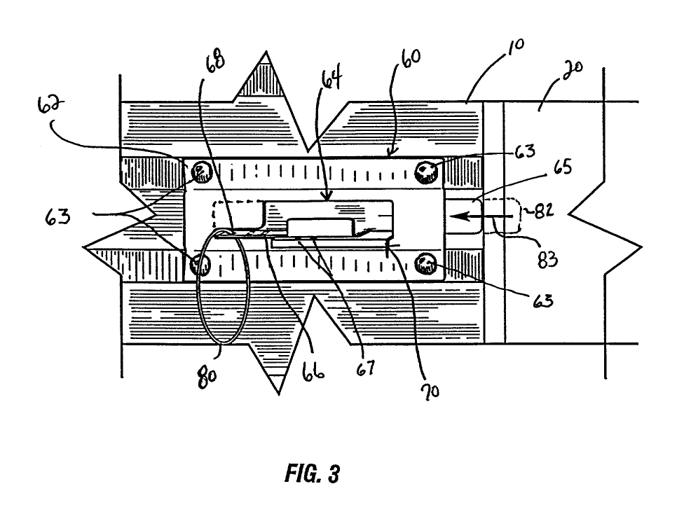

FIG. 2 shows the details of the latching mechanism 60 in the “closed” position. Latching mechanism 60 includes latch plate 62 and latch 64. Latch plate 62 is mounted to door 10 by bolts 63. Latch plate 62 is cut out in such a way that it not only holds latch 64, but also allows latch 64 to move from an open position (FIG. 3) to a closed position (FIG. 2) or vice versa. Latch 64 includes latch handle 69, latch holes 66, loop hole 68 and latch locking piece 65. Latch 64 is slidingly supported upon latch plate shelf 70 which is located underneath latch handle 69 and which extends outwardly from latch plate 62. Disposed through loop hole 68 is loop 80. Loop 80 may be constructed of plastic, wire, rope or the like. In the closed latch position as illustrated in FIG. 2, latch 64 is pushed to the right using either latch handle 69 or loop 80. A handicapped person can use loop 80 to move latch 64 if he can not grip latch handle 69. When the latch is pushed to the right, latch locking piece 65 moves in the direction of arrow 81 and moved into a hole 82 in wall 20. When the latch 64 is in the “closed” position (FIG. 2.), latch holes 66 line up with corresponding latch plate shelf holes 67 on latch plate shelf 70. Such alignment allows a lock (not shown) or other similar device to be disposed through both holes (latch hole 66 and latch plate shelf hole 67) preventing access by unauthorized individuals.

FIG. 3 shows essentially the same details as FIG. 1, but the latch 64 is now in the “open” position. In the “open” position, latch 64 is pushed to the left using either latch handle 69 or loop 80. When latch 64 is pushed to the left, latch locking piece 65 is moved in the direction of arrow 83 and out of hole 82 in wall 20.

It is to be understood that the invention is not limited to the exact details of construction, operation, exact materials, or embodiments shown and described, as obvious modifications and equivalents will be apparent to one skilled in the art. For example, the improved latching mechanism could be placed on a gate instead of a door. Further, the loop is not required to be circular and may have any shape desired or necessary to facilitate a person passing a finger or prosthesis through the loop to move the latch from its open position to its closed position and vice versa. Also, the loop can be made of a variety of materials including, but not limited to plastic, wire, rope, or the like. The components of the latching mechanism may be manufactured out of any material and through any method known by persons of ordinary skill in the art. Accordingly, the invention is therefore limited only by the scope of the claims.

What is claimed is:

1. A latching mechanism, which includes a latch and a latch plate, comprising an improvement, characterized by:
a loop attached thereto, wherein the loop is arranged and designed for movement without gripping by a person for moving the latch between open and closed positions with respect to the latch plate.

2. The latch of claim 1, further comprising:
a hole in the latch, wherein the loop is disposed through the hole.

3. The latch of claim 2, wherein the latching mechanism is connected to a door.

4. The latch of claim 3, wherein the door is a roll-up type door as used in storage units.

5. A latching mechanism, which includes a latch and a latch plate, wherein the latch has an open position and a closed position, comprising an improvement characterized by:
a loop attached thereto, wherein the loop is arranged and designed for movement without gripping by a person for moving the latch between open and closed positions with respect to the latch plate.

6. The latch of claim 5, further comprising:
a hole in the latch, wherein the loop is disposed through the hole.

7. The latch of claim 6, wherein the latching mechanism is connected to a door.

8. The latch of claim 3, wherein the door is a roll-up type door as used in storage units.
